(19) United States
(12) Patent Application Publication
(10) Pub. No.: US 2010/0193304 A1
(43) Pub. Date: Aug. 5, 2010

(54) DAMPING DEVICE WITH FIELD-CONTROLLABLE FLUID

(75) Inventors: Holger Böse, Wurzburg (DE); Thomas Gerlach, Schweinfurt (DE); Jörn Probst, Kurnach (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Fraunhofer-Gesellschaft zur Forderung der angewandten Forschung e.v., Munchen (DE)

(21) Appl. No.: 12/595,655

(22) PCT Filed: Apr. 11, 2008
(86) PCT No.: PCT/EP08/02899

§ 371 Date: Mar. 25, 2010

(30) Foreign Application Priority Data
Apr. 13, 2007 (DE) 10 2007 017 589.4

(51) Int. Cl. F16F 9/53

(52) U.S. Cl. 188/267.2

(57) ABSTRACT

The present invention relates to a damping device having a first control element with a first surface (O1) and a second control element with a second surface (O2), the two control elements being moveable relative to each other with their two surfaces, a spatial region (intermediate space Z) which is filled at least partially with a magnetorheological and/or electrorheological material (M) and is disposed between the first and the second surface, and a field producer (4) with which a magnetic and/or electrical field can be produced in at least a partial region of the material-filled part of the intermediate space, and also a housing (1) which has two chambers (K1, K2) and in which a piston unit (2) which is moveable relative to the housing and a closing unit (3) which is moveable relative to the piston unit are disposed, the piston unit and the closing unit forming a throughflow opening (D) connecting the two chambers, through which a fluid (F) can be displaced between the two chambers by means of a relative movement of piston unit and housing, the opening cross-section of the throughflow opening being able to be changed by means of a relative movement of piston unit and closing unit (3) and the closing unit and one of the control elements (O1) being coupled such that the relative movement of piston unit and closing unit can be controlled by means of the field strength in the intermediate space.

The present invention relates to a damping device, in particular a shock absorber or a vibration damper, with a field-controllable fluid (magnetorheological and/or electrorheological fluid). The invention relates furthermore to a damping method in which such a damping device is used and also to the use of such a damping device.

Magnetorheological fluids (MRF) are suspensions of magnetically polarisable particles in a carrier fluid, the viscosity and other rheological properties of which can be changed rapidly and reversibly in a magnetic field. Analogously thereto, electrorheological fluids (ERF) are suspensions of electrically polarisable particles in a non-conductive carrier fluid, the rheological properties of which can be changed rapidly and reversibly in a magnetic field. Both classes of fluids hence offer an ideal basis for adaptive damping devices (e.g. shock absorbers or vibration dampers), the transmission forces of which are controlled by the magnetic field or the electrical field.

Magnetorheological fluids, as can be used in the present invention, are described in the German patent specification DE 10 2004 041 650 B4 which is introduced herewith in its entire scope as a component of the present application.

Damping devices are already known from the state of the art, in which a damping force is produced by a magnetorheological or electrorheological fluid in a magnetic or in an electrical field. One advantage of such damping devices resides in the short reaction time to a change in field strength. Thus DE 20 2004 008 024 U1 describes a movement damper which comprises a control- and an operating unit, the operating unit having a controllable valve and the control unit containing a magnetorheological fluid. The illustrated device has a thrust piston in the control unit which presses the magnetorheological fluid through a gap in which a magnetic field is applied. As a result, the flow resistance of the magnetorheological fluid is drastically increased. This flow movement of the magnetorheological fluid through the gap hence concerns a magnetorheological valve. However such a valve can become entirely or partially blocked by the particles in the magnetorheological fluid, as a result of which the controllability is impaired or even lost. Furthermore, such a flow system is associated with cross-sectional changes and/or deflections of the flow direction of the magnetorheological fluid and hence accompanying flow resistances. Because of the flow of the magnetorheological fluid through the magnetorheological valve, the result at these places can be accumulations of particles from the magnetorheological fluid (MRF), as a result of which the functional capability of the damper is impaired.

It is therefore the object of the present invention to make available a damping device (and a corresponding damping method) which avoids the above-described disadvantages of the state of the art, with which a field-controllable damping can be achieved in particular in a mechanically simple, reliable manner.

This object is achieved by a damping device according to claim 1, by a damping device according to claim 2, and also by a damping method according to claim 22. Advantageous embodiments of the damping devices according to the invention are revealed in the respectively dependent patent claims. A use according to the invention is described in claim 23.

Subsequently, the subsequent invention is now firstly described in general, individual embodiments then following this general description. Individual features according to the invention, as are described subsequently, can hereby occur not only in combinations as shown in the special advantageous embodiments but they can also be configured or used within the scope of the present invention in any other combinations.

The basis of the solution according to the invention is the provision of two surfaces in the control unit which can be moved relative to each other (either moved laterally one past the other or towards or away from each other) so that the magnetorheological fluid need not flow through a magnetorheological valve but is sheared and/or squeezed in an intermediate space between these two surfaces in the control unit. A magnetic field or an electrical field is hereby produced in this intermediate space by a field producer (magnet or electrodes), as a result of which the field strength in the field-controllable fluid can be changed in this intermediate space. In the case of using a magnetorheological fluid and a magnet (electromagnet), the intermediate space filled with the MRF is hence situated in the magnetic circuit system of the damping device. The same applies in the case of using electrodes, an electrical field and an electrorheological fluid. As is described subsequently in even more detail, a corresponding change in the mechanical coupling of two control elements of the control unit can be effected by changing the magnetic or electrical field strength, said control units having the above-described surfaces. As a result, as described even more precisely subsequently, a relative movement (for example between a piston unit and a closing unit or also between a closing unit and a housing element) can be controlled in the operating unit, as a result of which the opening cross-section of a throughflow opening, which connects two chambers within one housing which are separated by a piston, can be changed. As a result of such a changed opening cross-section, the flow of a non-field-controllable fluid between the two chambers within the housing can be made difficult or facilitated, as a result of which the damping of the piston unit within the housing can be correspondingly adapted as desired.

The damping device according to the invention, relative to the damping devices known from the state of the art, has a series of significant advantages:

In the case of the device according to the invention, the use of a thrust piston which presses the MRF through a gap subjected to a magnetic field flow (flow system) is not necessary. Hence significantly lesser demands are made upon the properties of the magnetorheological fluid and a significantly more reliable operation of the damping device is possible. For example, in the basic state, the MRF without a magnetic field can be very viscous, even magnetorheological gels for example which are not intrinsically free-flowing can be used instead of a magnetorheological fluid. Hence problems which occur in the MRF because of sedimentation of the magnetic particles are avoided.

A further advantage is that also no mechanically complex system is produced in the case of the damping device according to the invention (as was produced for example in DE 20 2004 008 024 U1 by configuring the control unit with a thrust piston, with separate flow channels for the MRF and with an additional membrane which is susceptible with respect to overloading (tearing) and is necessary for connection to the operating unit).

The two mutually moveable surfaces used in the present invention can be coupled mechanically to each other by the MRF or electrorheological fluid stiffened in the magnetic field or electrical field in the intermediate space between the surfaces. A simple and reliable fixing of the opening cross-section of the valve in the operating unit is herewith possible.

A further advantage of the present invention resides quite generally in the separation into a control- and an operating unit, as a result of which a low force generated in the control unit can produce a high damping force in the operating unit. As a result, the relatively heavy unit containing the MRF need not be designed to be so large. This involves a lower energy requirement; in addition, a low basic damping in the operating unit is possible because of this principle so that altogether a very high factor between the maximum and the minimum damping force is produced.

Fields of application of the damping device or force transmission device according to the invention are in particular electrically controllable shock absorbers and vibration dampers in which the damping force is changed via the opening cross-section of the valve in the operating unit, the opening cross-section being controlled by the magnetic field or the electrical field in the control unit.

The present invention hence describes a damping device which can be divided essentially into two units, a control unit and an operating unit. In the control unit which contains the magnetorheological or the electrorheological fluid, the two mutually moveable surfaces, between which the MRF or the electrorheological fluid is situated in the intermediate space, are mechanically coupled to each other by applying a magnetic or electrical field (which then covers the intermediate space). According to the field strength, the two surfaces can be moved relative to each other more or less easily. After switching off the field, both surfaces can be moved relative to each other again entirely without a field-produced resistance, a shear movement and/or a squeezing movement being effected with respect to the magnetorheological or electrorheological fluid.

In the second unit, the operating unit, which contains a non-field-controllable fluid (or even a gas), the force to be dampened is exerted on a piston unit or a moveable piston. During the movement of the piston or of the piston unit, the non-field-controllable fluid is transported through an opening (throughflow opening) between two chambers which are separated from each other by the piston, the opening cross-section of the throughflow opening and hence the flow resistance being able to be changed by the movement of a closing unit (for example a tappet).

Advantageously, the piston unit and the closing unit which is moveable relative thereto can be connected mechanically rigidly to the two surfaces or to the two control elements in the control unit, between which the magnetorheological or electrorheological fluid is situated. Another advantageous possibility resides in the fact that merely the closing unit is connected mechanically rigidly to one of the two surfaces or to one of the two control elements in the control unit which is moved relative to the other surface and thereby the field-controllable fluid situated in the intermediate space between the surfaces is sheared and/or squeezed.

Advantageously, the damping device according to the invention hence has a control unit which contains a magnetorheological or an electrorheological material and also an operating unit which contains a non-field-controllable medium (fluid or gas). The control unit hereby comprises at least two mutually moveable surfaces, between which the magnetorheological or electrorheological material is subjected to a shear movement and/or squeezing movement and also a magnetic field producer (magnetic circuit) which stiffens the magnetorheological material between the surfaces (alternatively thereto, an electrical field production which stiffens the electrorheological material between the surfaces is possible). The operating unit has a damping piston which separates the two chambers from each other, which chambers are connected to each other by a valve with a variable opening cross-section which is formed from at least two mutually moveable parts. At least one of the mutually moveable parts of the valve in the operating unit is hereby connected mechanically rigidly to at least one of the mutually moveable surfaces in the control unit.

Advantageously, the two mutually moveable surfaces of the control unit or the corresponding control elements are formed by two cylinder elements (tubes) which are inserted one in the other concentrically or by two plane-parallel plates which are disposed parallel to each other and can be mutually moved laterally or can be moved towards each other and away from each other. The piston unit can be configured advantageously such that the piston performs a linear movement in the operating unit. The magnetic or electrical field hereby extends advantageously perpendicular to the two surfaces of the control elements and penetrates the gap between the surfaces or the intermediate space. If a magnetorheological fluid is used, then the mutually moveable surfaces are situated advantageously in a magnetic circuit with a coil, the current flowing in the coil producing the magnetic field. In the case of an electrorheological fluid, the two mutually moveable surfaces advantageously also form the electrodes between which the electrical field is configured. As a result of the magnetic or electrical field, the mutually moveable surfaces are connected to each other frictionally via the stiffened magnetorheological or electrorheological fluid so that, with sufficiently high field strength, the moveability of the two surfaces relative to each other is removed. If a sufficiently strong field is applied, stiffening of the field-controllable fluid and a secure coupling of the two control elements or surfaces is hence effected.

However, in another advantageous embodiment, it is also possible to construct the damping device according to the invention on the basis of a rotary piston unit. A rotary vibration is then dampened, during which a control- and an operating unit are likewise produced in the damping device. As in the case of the linear dampers, the movement of a rotary piston is correspondingly dampened in the operating unit by means of the throughflow of the non-field-controllable fluid which is displaced by the rotary piston through a gap (throughflow opening or valve gap). The cross-section of the throughflow opening can be changed, at least one of the mutually moveable parts forming the gap advantageously being connected mechanically rigidly to one of the mutually moveable surfaces in the control unit. The two surfaces in the control unit, between which the magnetorheological or electrorheological fluid is situated in an intermediate space, are integrated just as with the linear damper, in a magnetic circuit or serve as electrodes for producing the electrical field.

A further advantageous possibility resides in the two mutually moveable parts which determine the opening cross-section of the valve in the operating unit (piston unit and closing unit in the case of the linear movement of the piston or housing element and closing unit in the case of the rotary movement of the piston) being retained in an equilibrium position relative to each other by a spring. Hence a pre-adjustment of the damping force without an applied field (operating point of the damping device) is defined.

Advantageously, in addition a sensor can be provided which detects the relative position of the two mutually moveable parts of the valve in the operating unit. The opening cross-section of the valve can be herewith detected. Advantageously, a control circuit must then be provided in addition in which, on the basis of the detected relative position values, firstly the opening cross-section can be determined and, on the basis of the determined opening cross-section, then the field strength of the magnetic and/or of the electrical field in the intermediate space can be regulated (adaptation of the actual damping properties).

In a further advantageous embodiment variant, it is possible to provide at least one permanent magnet in addition to an electromagnet in the magnetic circuit of the control unit. As a result of such integration of an additional permanent magnet which likewise affects the magnetic field for the magnetorheological fluid in the intermediate space in the control unit, an opening cross-section of the valve in the operating unit can be fixed without energy expenditure (adjustment of the operating point of the damping device; mechanical coupling of the two surfaces without current flow in the coil of the electromagnet is possible).

Further advantageous embodiment variants reside in the fact that, instead of an MRF, there is used as field-controllable material a magnetorheological gel (MRG), a magnetorheological elastomer (MRE) or a magnetorheological foam (MRS) or a combination of such materials. An MRG is hereby a material which is in fact soft in contrast to an MRF but is not fluid. Analogously to an MRF, it can be deformed irreversibly in any manner and can be stiffened in the magnetic field analogously to an MRF. An MRE is a cross-linked material which therefore has a prescribed shape, from which it can be deformed reversibly only in a limited manner. An MRS is an elastomer foam, the pores of which are filled with an MRF. Like the MRE, an MRS also has a prescribed shape from which it can be deformed reversibly only in a limited manner. In the case of MRE or MRS, a restoring force can be produced between the mutually moveable surfaces at the same time due to the elasticity of the material, which restores said surfaces back into their respective starting position after switching off the magnetic field.

In a further advantageous embodiment variant, there can be used as field-controllable material, instead of an electrorheological fluid ERF, an electrorheological gel (ERG), an electrorheological elastomer (ERE) or an electrorheological foam (ERS). These materials are defined entirely analogously to the corresponding magnetorheological materials or have the properties of the corresponding magnetorheological materials.

A particularly advantageous selection of the non-field-controllable fluid in the operating unit resides in using the same fluid which is also used as carrier fluid in the magnetorheological or electrorheological fluid also as non-field-controllable fluid.

Instead of using a non-field-controllable fluid, a gas can also be used in the operating unit.

The subsequent invention is described subsequently with reference to individual embodiments. In the individual Figures which are associated with the embodiments, the same or corresponding elements of the damping device are hereby designated with identical reference numbers.

There are shown:

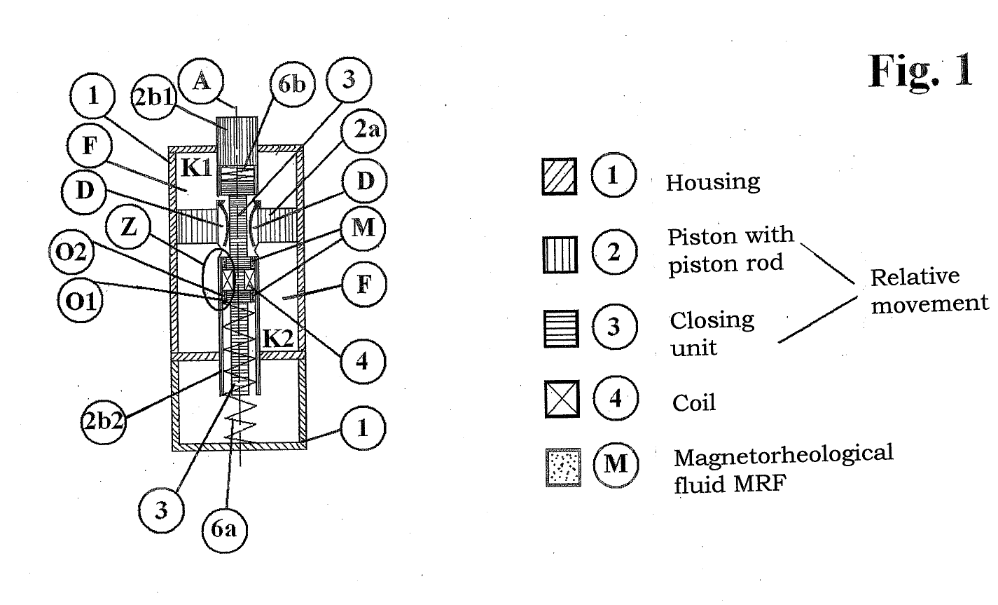

FIG. 1 a damping device according to the invention which is configured as a linear vibration device.

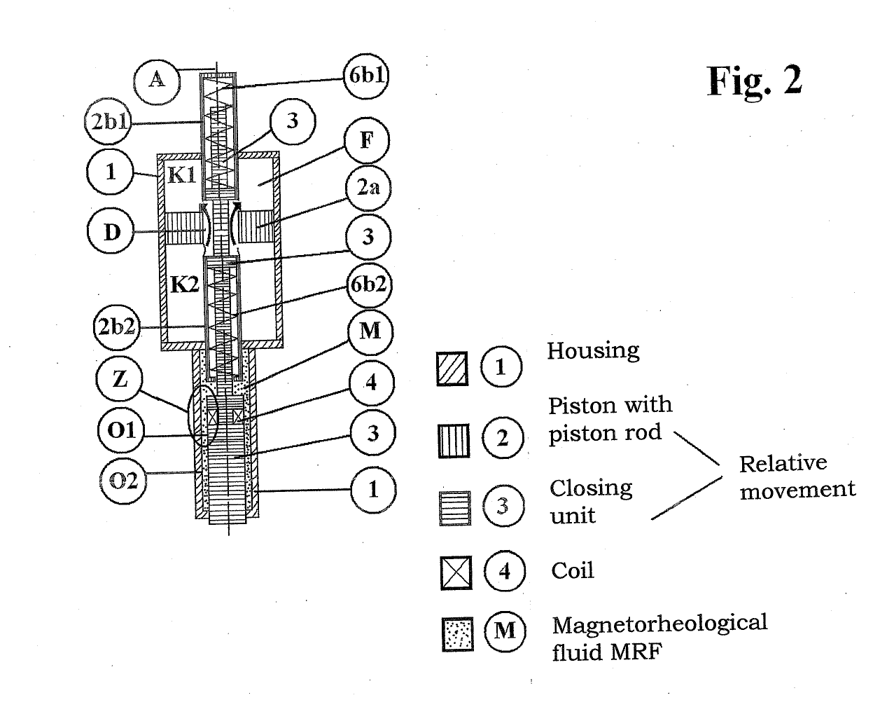

FIG. 2 a second linear vibration device according to the invention.

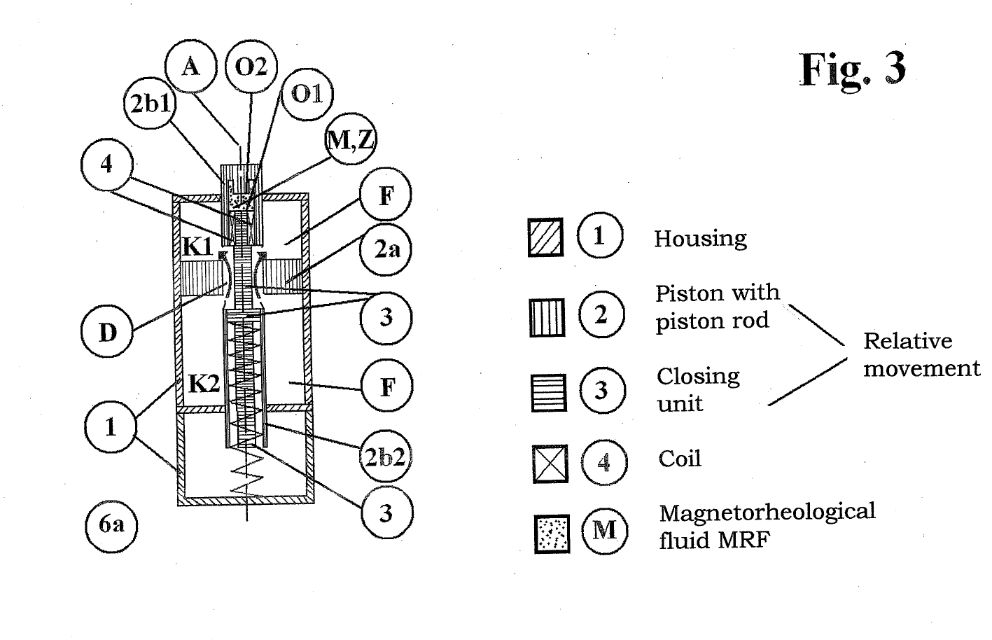

FIG. 3 a third linear vibration device according to the invention.

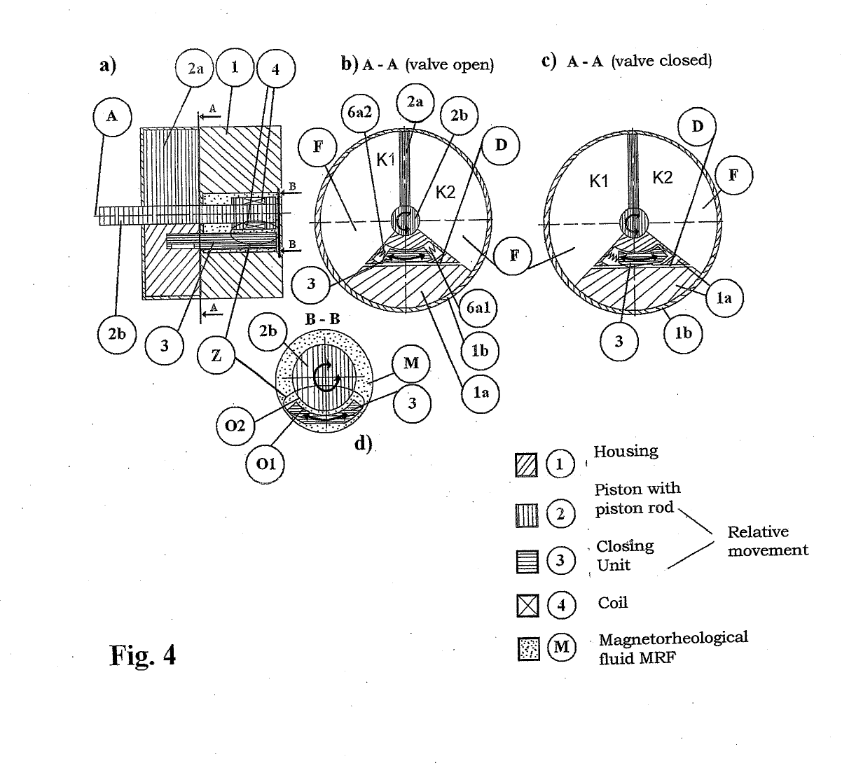

FIG. 4 a damping device according to the invention which is configured as a rotary vibration device.

### EMBODIMENT 1

FIG. 1 shows a damping device according to the invention which is constructed as a linear vibration unit. The damping device comprises a housing 1. A piston unit 2 is disposed in this housing 1. The piston unit 2 is moveable within the housing 1 along an axis of symmetry A of the housing 1, i.e. relative to the housing 1. Housing 1 and piston unit 2 hereby form cylinder units which are disposed one in the other concentrically. FIG. 1 shows a section through the central axis of symmetry A in the longitudinal direction of this unit. The device is rotationally symmetrical about the longitudinal axis A. The housing 1 comprises two housing parts which are disposed abutting one against the other in the direction of the axis A: in the upper region, comprising a first housing part 1a in which two chambers K1 and K2 are separated by the piston 2a of the piston unit 2, and in the lower region, comprising a second housing part 1b into which, as described subsequently in even more detail, a part of the piston unit 2 protrudes. The piston unit hereby comprises three elements: firstly an upper piston rod part 2b1 which is disposed partially within the upper housing part and partially outwith the upper housing part (the upper cylindrical cover surface of the upper housing part surrounds this part 2b1 forming a seal so that the chambers K1 and K2 form a space which is sealed to the exterior by the housing 1 and the upper piston rod part. The piston 2a is connected mechanically rigidly to the upper piston rod part 2b1 (not shown). Said piston is disposed concentrically within the upper housing part such that it seals the upper chamber K1, apart from the throughflow opening D which is also described later, completely from the lower chamber K2. On the side of the piston 2a situated opposite the part 2b1, the lower piston rod part 2b2 is disposed, connected mechanically rigidly to this (not shown). Said piston rod part is surrounded in a seal by the lower cover surface of the upper housing part 1 so that the upper part of the lower piston rod part 2b2 protrudes partially into the chamber K2 and protrudes partially from the underside of the lower cylindrical cover surface of the upper housing part into the lower housing part. The lower cylindrical cover surface of the upper housing part surrounds the piston rod part 2b2 in a seal in such a manner that the two chambers K1 and K2 are sealed in a gas- or fluid-tight manner relative to the lower part of the housing 1.

By displacing the piston unit which has the three elements 2a, 2b1 and 2b2 relative to the housing 1, the relative volume ratio of the two chambers K1 and K2 (with a constant total volume of these two chambers) is changed so that a non-magnetorheological fluid F which fills the two chambers K1 and K2 and also the throughflow opening D is conducted by the piston movement of the piston 2a through the throughflow opening D from the one chamber into the other chamber.

Concentrically within the piston unit 2 and enclosed in portions in a seal by the two piston rod parts 2b1 and 2b2 which are configured as hollow cylinders, a closing unit 3 is disposed. This closing unit 3 is likewise constructed rotationally symmetrically like the piston unit 2 and is disposed rotationally symmetrically about the central axis A. This closing unit 3 is situated hence inserted within the housing in the piston unit 2 and is moveable relative to the piston unit 2 (and also relative to the housing 1) along the axis A. As a result of the relative movement of piston unit 2 and closing unit 3 and because of a suitable section-wise subdivision of the closing unit 3 along the axis A into cylinder portions with a different radius, a valve is configured together with the elements 2a, 2b1 and 2b2 of the piston unit and forms the throughflow opening D between the two chambers K1 and K2. The configuration is hereby effected such that a change in the relative position of piston unit 2 and closing unit 3 relative to each other along the axis A changes the opening cross-section of the throughflow opening D.

In that part of the closing unit 3 which, as represented in the Figure, is inserted into the lower portion 2b2 of the piston unit 2, the closing unit 3 now has two cylindrical portions along the axis A, which have a smaller outer diameter than the inner diameter of the lower piston rod part 2b2. Between these two cylinder elements there is situated the coil winding 4 of an electromagnet which is disposed in the form of a toroid rotationally symmetrically about the axis A within the lower piston rod part 2b2 such that a magnetic field can be produced therewith in the intermediate space Z (which is configured on the basis of the different outer diameters of the two cylindrical portions and the inner wall surface of the lower piston rod part 2b2 between these cylindrical portions and this inner wall surface). If such a magnetic field is produced by means of the electromagnet 4, then the magnetic field lines in the region of the intermediate space Z extend perpendicular to the outer wall surface of the two cylindrical portions of the closing unit 3 and perpendicular to the inner wall surface of the lower piston rod unit 2b2 which surrounds these cylindrical portions concentrically. In the illustrated case, the magnet 4 is connected securely to the closing unit 3 between the two cylindrical portions of the closing unit 3 at the level of the lower piston rod part 2b2.

This intermediate space Z is now filled with a magnetorheological fluid M. The inner wall surface of the lower piston rod unit 2b2 at the level of the two cylindrical portions (along the axis A) hereby forms the second surface O2 which is configured on the second control element. The outer surface of the two cylindrical portions of the closing unit 3 hereby forms the first surface O1 which is configured on the first control element. The first control element is hence configured here as part (two cylinder portions) of the closing unit 3 and hence is also connected mechanically to the closing unit 3 because of this configuration. The second surface O2 or the second control element likewise forms a part of the lower piston rod unit 2b2.

The illustrated damping device has furthermore two spring units 6a and 6b configured as tension-compression springs. The spring unit 6a hereby connects the lower cylinder cover of the lower housing part of the housing 1 to the lower portion of the closing unit 3 which is disposed in the region of the lower piston rod unit 2b2. The second spring 6b connects the upper portion of the closing unit 3 (which is disposed within the upper piston rod unit 2b1) to the side (inner side or underside U), which is orientated towards the unit 2b2, of the upper sealing element of the piston rod unit 2b1. By means of these two springs 6a and 6b, the relative position of the closing unit 3 to the piston unit 2 is adjusted (operating point of the damper) such that the opening cross-section of the throughflow opening D is maximum. By deflecting the closing unit 3 (relative to the piston unit 2) from this equilibrium position, the opening cross-section of the throughflow opening D can hence be reduced in size.

This takes place, as now described, with the help of an applied magnetic field in the intermediate space Z and with the help of the MRF situated there: when the magnetic field is switched off and during a movement of the piston unit 2 downwards, for example the closing unit 3 can no longer follow the piston unit 2 because of the inertia thereof. As a result, the cross-section of the throughflow opening D is correspondingly reduced. If then a magnetic field of sufficient strength is produced in the intermediate space Z at a suitable point in time so that the MRF is stiffened, then the two elements 2 and 3 are coupled securely to each other frictionally via the MRF. A relative movement of piston unit 2 and closing unit 3 is then no longer possible so that the opening cross-section of the throughflow opening D remains constant at a value which is less than the maximum opening cross-section. The flow of the fluid F between the two chambers K1 and K2 is hence made difficult, as a result of which stronger damping of the damping device is produced.

This embodiment hence shows a damping device with magnetorheological fluid with a shear movement in the intermediate space Z, two mutually moveable parts of the valve in the operating unit (piston 2a and also portions of the rod parts 2b1 and 2b2, orientated towards it, and upper region of the closing unit 3) being connected respectively mechanically rigidly to the two mutually moveable control elements or surfaces in the control unit (surface region O2 of the lower piston rod unit 2b2 and the surface region O1 of the closing unit 3 situated opposite said surface region O2). The closing unit 3 can hence be moved relative to the unit comprising piston and piston rod. The closing unit 3 is connected both to the piston rod 2b and to the housing 1 by the springs 6a, 6b which affect this relative movement. As a result of the relative movement of the elements 2 and 3, the opening cross-section of the valve is changed. By stiffening the MRF in the intermediate space Z between the outer surface of the closing element 3 and the inner surface of the lower piston rod unit 2b2, the two elements 2, 3 can be coupled rigidly. Hence, their relative movement is prevented and the opening cross-section of the valve remains constant. The MRF is used in shear mode in this example.

### EMBODIMENT 2

FIG. 2 shows a linear damping unit which is constructed, apart from the subsequently described differences, just like the unit shown in FIG. 1. The housing 1 here comprises an upper housing part 1a (operating unit) in which the piston 2a is disposed and a lower housing part 1b (control unit). The upper portion of the lower rod part 2b2 and the lower portion of the upper rod part 2b1 protrude into the upper housing part 1a and, in this housing part 1a, the upper region of the closing unit 3 is disposed. In the lower housing part 1b, into which the lower portion of the lower piston rod unit 2b2 protrudes, the lower region of the closing unit 3 is disposed. In the lower housing part 1b, the magnetorheological fluid MRF or M is also accommodated. In this case, the closing unit 3, in the region below the lower piston rod unit 2b2, has a portion which comprises the coil of the electromagnet 4 and the cylinder portions which are disposed on both sides thereof and form the first control element or the first surface O1. The second control element or the second surface O2 is configured here by the inner wall surface of the lower housing part 1 which surrounds this portion of the closing unit 3 concentrically. Between this inner wall surface and the lower portion of the closing unit 3 there is located the intermediate space Z which, as described previously, is filled with the magnetorheological fluid M.

Hence this Figure also shows an embodiment with a magnetorheological fluid under shear, here however merely a moveable part of the valve in the operating unit (upper portion of the closing unit 3) being connected mechanically rigidly to the surface O1 which is moveable relative to the housing 1 in the control unit. The other surface O2 or the other control element is hereby configured by the stationary interior portion of the lower housing part 1.

The closing unit 3 here can also perform a relative movement to the piston unit 2. The closing unit 3 is connected here via two springs 6b1 and 6b2 both to the upper end and to the lower end of the piston rod 2b. As a result of the stiffness of these two springs 6b1, 6b2, the operating point can be established similarly as described in the first embodiment. The field-producing unit 4 is connected securely to the lower portion of the closing part 3. As a result of a magnetic field-dependent shearing of the MRF which is situated, as described, between the surface of the lower portion of the closing element 3 and the inner surface of the lower housing portion 1 of the control unit, a relative movement of the closing element 3 to the unit comprising piston and piston rod can be produced. The opening cross-section of the valve is influenced in this way. If no magnetic field is acting, the closing element 3 is moved by the springs into its starting position.

### EMBODIMENT 3

FIG. 3 shows a further linear damping device according to the invention which, apart from the subsequently described differences, is constructed just like the embodiment according to FIG. 1.

In this case, the upper portion of the closing unit 3 (that portion which is disposed concentrically within the upper piston rod unit 2b1) has a coil 4 of an electromagnet which is connected securely thereto. Between the upper end-face of the closing unit 3 and the coil 4 and the inner end-side of the upper cover of the upper piston rod unit 2b1, the intermediate space Z which is filled with the magnetorheological fluid M is disposed here. The two surfaces O1 and O2 of the control elements are hence, in the present case, end-faces of the piston unit 2 and of the closing unit 3 which are disposed perpendicular to the central axis A. As a result of the relative movement of the units 2 and 3 to each other, the extension of the intermediate space is hence extended or contracted along the axis A (change in spacing of the surfaces O1 and O2 in the direction of the surface normal).

This embodiment hence shows a linear damping device with a magnetorheological fluid M (alternatively thereto, a magnetorheological elastomer can also be used) with squeezing, respectively one of the two mutually moveable parts of the valve in the operating unit (piston 2a and the portion of the closing unit 3 which is disposed along the axis A at this level) being connected mechanically rigidly to respectively one of the two mutually moveable surfaces O1 and O2 of the control unit. Here also, piston and piston rod form a piston unit 2, the closing unit 3 being able to perform a relative movement to this unit. As a result of this relative movement, the opening cross-section of the valve and hence the damping is again influenced. Furthermore, the lower portion of the closing element 3 is connected via a spring 6a to the lower closing cover of the lower housing portion of the housing 1. This spring is configured as tension-compression spring. The upper portion of the closing element 3 is coupled via the MRF in the intermediate space Z to the inside end-face of the upper piston rod unit 2b1. As a result of the relative movement of the closing element 3 to the piston rod unit 2b1, the MRF is displaced or squeezed between the two squeezing surfaces O1, O2. Due to the magnetic field of the coil 4, the resistance to this displacement can be influenced and hence the opening cross-section of the valve adjusted. Via the length and stiffness of the lower spring 6a, the equilibrium position of the valve opening and the relative movement between piston unit 2 and closing element 3 can be influenced. According to the magnetic field strength in the intermediate space Z, a relative movement between piston unit 2 and closing element 3 is possible or not. The MRF is hence used here in squeezing mode.

### EMBODIMENT 4

FIG. 4 shows a further embodiment of a rotary vibration damping device according to the present invention. This device has a similar mode of operation in principle to the device described in FIG. 1; identical or corresponding device elements are therefore provided with identical reference numbers.

FIG. 4a hereby shows a section through a plane in which the central axis A (at the same time axis of rotation here) of the rotary piston unit 2 is situated. FIGS. 4b and 4c show a section perpendicular to this plane or to the axis of rotation A at the level A-A. FIG. 4d shows a corresponding section at the level B-B.

The rotary piston 2 is secured rigidly here on the input shaft of the axis of rotation A and has a shaft portion 2b which is disposed rotationally symmetrically about the axis A and also a wing element 2a which protrudes therefrom radially symmetrically. According to the position of the wing element (see FIGS. 4b and 4c), chamber volumes of different sizes of the two chambers K1 and K2 are produced in the housing 1. The cylindrical housing 1 hereby has a separating element 1a (represented approximately triangulary in FIGS. 4b and 4c) which separates the two chambers K1 and K2 from each other. This element is disposed along a part of the housing outer circumference and extends from the inner wall surface of the housing circumference 1b inwardly up to the axis A. Furthermore, it extends, viewed along the axis A, in a seal up to the input shaft portion 2b. The throughflow opening D is configured as valve gap in the separating element 1a. By moving the wing portion 2a along the outer circumference of the housing 1 and within the housing interior, the non-magnetorheological and non-electrorheological fluid F is hence moved to and fro by being pressed through the valve gap D between the two chambers K1 and K2 (change in chamber volumes). Within the separating element 1a, the closing unit 3 is mounted approximately concentrically about the axis of rotation A and at a spacing from the latter. The form of this mounting or of the closing unit 3 corresponds approximately to the partial portion (sector) of a hollow cylinder. The closing unit 3 is hereby connected via two tension-compression springs 6a1 and 6a2 to the mounting in the separating element 1a such that it is rotatable about the axis A over a small angle portion (angle sector). This rotation makes it possible for the opening D to be closed in one position (FIG. 4c) and, in another position of the unit 3 (FIG. 4b), for the opening D to be passable. The closing unit 3 is hereby retained by the two springs 6a1 and 6a2 in an equilibrium position (in this the valve is opened).

The first control element (or the first surface O1) is hereby configured as the inner wall portion of the closing unit 3 which is orientated towards the axis A. The second control element (or the second surface O2) is hereby configured as the outer wall portion of the input shaft element 2b which is orientated away from the axis A. As FIG. 4D shows, the intermediate space between these two control elements is filled with the magnetorheological fluid MRF or M. Furthermore, in the region of the intermediate space Z, the electromagnet 4 in the form of a toroid which is disposed rotationally symmetrically about the axis A and is connected securely to the input shaft element 2b is disposed.

According to the magnetic field strength in the intermediate space Z, a more or less strong frictional coupling of closing unit 3 and input shaft portion 2b of the rotary piston unit 2 can hence be achieved. By suitable adjustment of the position of the rotary piston unit 2 relative to the housing, the restoring force of the springs 6a1 and 6a2 and also the field strength in the intermediate space Z, the relative position of the closing unit 3 relative to the ribbed portion of the housing 1 can hence be changed or adjusted. By influencing the arrangement of the closing unit 3 relative to the portion 1a of the housing 1, the relative movement of unit 2 and unit 1, according to the chosen field strength, effects a desired opening degree or the closure of the throughflow opening D of the valve gap between the two chambers K1 and K2. According to the position of the closing unit 3 relative to the housing 1, hence a stronger or a less strong damping of the rotary piston movement within the housing 1 is hence achieved.

In the illustrated example, the rotary piston 2a, 2b is hence mounted rigidly on the input shaft. Parallel thereto, the coil 4 for the field production is mounted on the input shaft element 2b. By means of the rotary movement of the wing portion 2a in the operating unit, the non-field-controllable fluid F is pressed through the valve gap D. The closing unit 3 can be moved relative to the housing 1 and to the input shaft or to the rotary piston 2. The closing element is retained by the two springs 6a1 and 6a2 in its starting position (equilibrium position). By moving the closing part portion 3 of the valve in its guide within the ribbed housing portion 1a, the opening width of the valve gap D and hence the damping in the operating unit can be influenced. Since the coil 4 is situated on the same shaft as the rotary piston, said coil is likewise moved during a rotary movement of the piston.

The relative movement of closing element 3 and housing 1 is caused by a magnetic field-dependent shearing (rotary shearing) of the MRF which is situated in the intermediate space Z between the two surfaces O1 and O2. If no magnetic field is acting in the intermediate space Z, the closing element 3 is moved by the springs 6 into its starting position or retained there.

1. A damping device having
a first control element with a first surface (O1) and a second control element with a second surface (O2), the two control elements being moveable relative to each other with their two surfaces, a spatial region (intermediate space Z) which is filled at least partially with a magnetorheological and/or electrorheological material (M) and is disposed between the first and the second surface, and a field producer (4) with which a magnetic and/or electrical field can be produced in at least a partial region of the material-filled part of the intermediate space, and also
a housing (1) which has two chambers (K1, K2) and in which a piston unit (2) which is moveable relative to the housing and a closing unit (3) which is moveable relative to the piston unit are disposed,
the piston unit and the closing unit forming a throughflow opening (D) connecting the two chambers, through which a fluid (F) can be displaced between the two chambers by means of a relative movement of piston unit and housing, the opening cross-section of the throughflow opening being able to be changed by means of a relative movement of piston unit and closing unit (3) and the closing unit and one of the control elements (O1) being coupled such that the relative movement of piston unit and closing unit can be controlled by means of the field strength in the intermediate space.

2. A damping device having
a first control element with a first surface (O1) and a second control element with a second surface (O2), the two control elements being moveable relative to each other with their two surfaces, a spatial region (intermediate space Z) which is filled at least partially with a magnetorheological and/or electrorheological material (M) and is disposed between the first and the second surface, and a field producer (4) with which a magnetic and/or electrical field can be produced in at least one partial region of the material-filled part of the intermediate space, and also
a housing (1) which has two chambers (K1, K2) and in which a piston unit (2) which is rotatable relative to the housing and a closing unit (3) which is moveable relative to the housing and to the piston unit are disposed,
the housing and the closing unit forming a throughflow opening (D) connecting the two chambers, through which a fluid (F) can be displaced between the two chambers by means of a relative movement of piston unit and housing, the opening cross-section of the throughflow opening being able to be changed by means of a relative movement of closing unit and housing and the relative movement of closing unit and housing being controllable by means of the relative movement of piston unit and housing and the field strength in the intermediate space.

3. The damping device according to claim 2, wherein
the closing unit (3) is coupled to one (O1) of the two control elements.

4. The damping device according to claim 1,
wherein the piston unit (2) is coupled to the other (O2) of the two control elements.

5. The damping device according to claim 1, having
at least one mechanical coupling and/or wherein at least one of the couplings is effected via a rigid, mechanical connection.

6. The damping device according to claim 1, wherein
one of the control elements is configured as part of the closing unit or as part of the piston unit.

7. The damping device according to claim 1, wherein
the two control elements are disposed and/or configured such that the relative movement of the two surfaces to each other for the magnetorheological and/or electrorheological material in the intermediate space is configured as a shear movement, as rotary shear movement, and/or as squeezing movement.

8. The damping device according to claim 1, having
at least one spring connection (6a) between closing unit and housing and/or at least one spring connection (6b) between closing unit and piston unit.

9. The damping device according to claim 1,
having a tension-, a compression- or a tension-compression spring.

10. The damping device according to claim 1, wherein
the surfaces or control elements which are moveable relative to each other are configured as plane-parallel plates which, at a constant spacing from plate plane to plate plane, are mutually displaceable laterally or moveable towards each other or away from each other or as concentrically disposed cylinder elements which are mutually displaceable along a common axis.

11. The damping device according to claim 1, having
a field producer in the form of at least one magnet and a magnetic circuit which is configured by this in the damping device and encompasses the intermediate space.

12. The damping device according to claim 11, having
at least one electromagnet and at least one permanent magnet in the magnetic circuit.

13. The damping device according to claim 1, having
a field producer in the form of at least one pair of electrodes together with at least one voltage source, the surfaces or parts of the control elements which are moveable relative to each other being configured as electrodes.

14. The damping device according to claim 1, wherein
the field producer is connected securely to the closing unit or the field producer is connected securely to the piston unit.

15. The damping device according to claim 1, wherein
a sensor configured and/or disposed to detect the relative position of closing unit and piston unit and/or the relative position of closing unit and housing.

16. The damping device according to claim 1, wherein
the fluid is a non-magnetorheological and a non-electrorheological fluid or the fluid is a gas.

17. The damping device according to claim 16, having
a fluid which comprises at least partially the same liquid which serves as carrier fluid of the magnetorheological and/or electrorheological material.

18. The damping device according to claim 1, wherein
the magnetorheological material comprises a magnetorheological fluid, a magnetorheological gel, a magnetorheological elastomer and/or a magnetorheological foam and/or the electrorheological material comprises an electrorheological fluid, an electrorheological gel, an electrorheological elastomer and/or an electrorheological foam.

19. The damping device according to claim 1, wherein
the piston unit is configured as a linear vibrator and/or in that the piston unit comprises at least one piston element (2a) and at least one piston rod 2(b).

20. The damping device according to claim 2, wherein
the rotatable piston unit is configured as rotary vibrator.

21. The damping device according to claim 1, which has
a configuration as shock absorber or vibration damper.

22. A magnetorheological and/or electrorheological damping method in which a movement of a piston unit within a housing is damped comprising producing a magnetic and/or an electrical field in an intermediate space which is filled at least partially with a magnetorheological and/or electrorheological material, wherein the method utilizes
a damping device according to claim 1.

23. (canceled)

24. A magnetorheological and/or electrorheological damping method in which a movement of a piston unit within a housing is damped comprising producing a magnetic and/or an electrical field in an intermediate space which is filled at least partially with a magnetorheological and/or electrorheological material, wherein the method utilizes a damping device according to claim 2.
